(19) United States
(12) Patent Application Publication
(10) Pub. No.: US 2025/0168744 A1
(43) Pub. Date: May 22, 2025

(54) ELECTRONIC DEVICE AND SYSTEM, AND COMMUNICATION CONNECTION METHOD FOR SAME

(71) Applicant: SAMSUNG ELECTRONICS CO., LTD., Suwon-si (KR)

(72) Inventors: Thi Loan DAO, Hanoi (VN); Thi Thuy Van Do, Hanoi (VN); The Nghia Nguyen, Hanoi (VN); Van Khanh Nguyen, Hanoi (VN)

(73) Assignee: SAMSUNG ELECTRONICS CO., LTD., Suwon-si (KR)

(21) Appl. No.: 19/028,387

(22) Filed: Jan. 17, 2025

Related U.S. Application Data
(63) Continuation of application No. PCT/KR2023/011058, filed on Jul. 28, 2023.

(30) Foreign Application Priority Data
Sep. 21, 2022 (KR) 10-2022-0119416

(51) Int. Cl. H04W 40/24; H04W 48/08; H04W 76/19

(52) U.S. Cl. CPC H04W 40/248; H04W 48/08; H04W 76/19

(57) ABSTRACT

An electronic device includes a communication interface, memory storing instructions and access permission client device information, and one or more processors, coupled with the communication interface and the memory, configured to control the electronic device. The instructions, when executed by the one or more processors individually or collectively, cause the electronic device to, based on identifying that at least one of a hotspot parameter or the access permission client device information is changed, transmit, through the communication interface, a first de-authentication message including the hotspot parameter to a first client device of which access is permitted and transmit, through the communication interface, a second de-authentication message to a second client device of which access is not permitted, and, based on receiving a probe request from the first client device, perform reconnection with the first client device by transmitting, through the communication interface, a probe response to the first client device.

### CROSS-REFERENCE TO RELATED APPLICATIONS

This application is a continuation application of International Application No. PCT/KR2023/011058, filed on Jul. 28, 2023, which claims priority to Korean Patent Application No. 10-2022-0119416, filed on Sep. 21, 2022, in the Korean Intellectual Property Office, the disclosures of which are incorporated by reference herein in their entireties.

### BACKGROUND

### 1. Field

The present disclosure relates to electronic devices, and more particularly, to an electronic device performing a function of an access point (AP) and/or a mobile hotspot, a system, and a communication connection method for the same.

### 2. Description of Related Art

The twenty-first century is referred to as the information era. To become the strong in the information era, it necessary to obtain a means for learning and/or obtaining relatively large amounts of information in a relatively quick manner. A stationary terminal such as a desktop personal computer (PC) was used as a representative example of data communication equipment. However, as technology progresses in the twenty-first century, portable and/or relatively small terminals such as laptops, personal digital assistants (PDA), smartphones, or the like may have increased in popularity.

Various wireless communication technologies for the portable small terminals have been developed. A representative example of the wireless communication technologies is wireless-fidelity (Wi-Fi), or Institute of Electrical and Electronic Engineers (IEEE) 802.11), in which a wired local-access network (LAN) communication for a computer may be replaced by a wireless LAN communication. Wireless communication networks based on Wi-Fi have an advantage in that Wi-Fi communication technologies may be compatible with various electronic devices and provide for a relatively high communication speed between the electronic devices.

### SUMMARY

According to an aspect of the present disclosure, an electronic device includes a communication interface, memory storing instructions and access permission client device information, and one or more processors coupled with the communication interface and the memory, and configured to control the electronic device. The instructions, when executed by the one or more processors individually or collectively, cause the electronic device to, based on identifying that at least one of a hotspot parameter or the access permission client device information is changed, transmit, through the communication interface, a first de-authentication message including the hotspot parameter to a first client device of which access is permitted and transmit, through the communication interface, a second de-authentication message to a second client device of which access is not permitted, and based on receiving a probe request from the first client device, perform reconnection with the first client device by transmitting, through the communication interface, a probe response to the first client device.

According to an aspect of the present disclosure, a system includes a host device, and a first client device of which access is permitted. The host device is configured to, based on identifying that at least one of a hotspot parameter or access permission client device information is changed, transmitting a first de-authentication message including the hotspot parameter to the first client device and transmitting a second de-authentication message to a second client device of which access is not permitted. The first client device is configured to, based on receiving, from the host device, the first de-authentication message including the hotspot parameter, transmitting, to the host device, a probe request based on the hotspot parameter. The host device is further configured to, based on receiving, from the first client device, the probe request, perform reconnection with the first client device by transmitting a probe response to the first client device.

According to an aspect of the present disclosure, a method for communication connection of an electronic device includes, based on identifying that at least one of a hotspot parameter or access permission client device information is changed, transmitting a first de-authentication message including the hotspot parameter to a first client device of which access is permitted and transmitting a second de-authentication message to a second client device of which access is not permitted, and based on a probe request being received from the first client device, transmitting a probe response to the first client device to perform reconnection with the first client device.

A non-transitory computer-readable storage medium storing computer-executable instructions for communication connection of an electronic device that, when executed by at least one processor of the electronic device, cause the electronic device to, based on identifying that at least one of a hotspot parameter or access permission client device information is changed, transmit a first de-authentication message including the hotspot parameter to a first client device of which access is permitted and transmit a second de-authentication message to a second client device of which access is not permitted, and based on a probe request being received from the first client device, transmit a probe response to the first client device to perform reconnection with the first client device.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a view schematically illustrating an aspect of the present disclosure, according to an embodiment;

FIG. 2A is a block diagram illustrating a configuration of an electronic device, according to an embodiment;

FIG. 2B is a view illustrating a detailed configuration of an example of an electronic device, according to an embodiment;

FIG. 3 is a view illustrating a communication connection method of an electronic device, according to an embodiment;

FIG. 4 is a sequence diagram illustrating a communication connection method between a host device and a client device, according to an embodiment;

FIG. 5 is a sequence diagram illustrating a communication connection method between a host device and an access permission device, according to an embodiment;

FIG. 6 is a sequence diagram illustrating a communication method between a host device and an access non-permission client device, according to an embodiment;

FIG. 7 is a view illustrating an example of an access permission device list, according to an embodiment;

FIGS. 8A to 8C are views illustrating data used for communication connection, according to an embodiment;

FIG. 9 is a sequence diagram illustrating a communication connection method between a host device and a client device, according to an embodiment;

FIG. 10 is a sequence diagram illustrating a communication connection method between a host device and an access permission device, according to an embodiment;

FIG. 11 is a sequence diagram illustrating a communication connection method between a host device and a client device, according to an embodiment;

FIG. 12 and FIGS. 13A to 13D are views illustrating a communication connection method between a host device and a client device, according to an embodiment;

FIG. 14 is a view illustrating a communication connection method between a host device and a client device, according to an embodiment;

FIG. 15 is a sequence diagram illustrating a communication connection method between a host device and a client device, according to an embodiment; and

FIG. 16 is a sequence diagram illustrating a communication connection method between a host device and a client device, according to an embodiment.

### DETAILED DESCRIPTION

Example embodiments of the present disclosure will be described with reference to the appended drawings hereinafter.

The terms used in the present disclosure are briefly described and then the present disclosure is described.

The terms used in embodiments of the present disclosure are selected as general terms which are widely used as much as possible in consideration of functions in the present disclosure but may be varied depending on intention of those skilled in the art or a precedent, appearance of new technologies, or the like. Also, if there is a term which is arbitrarily selected in a certain case and in this case, its meaning may be specifically described in the relevant description part of the present disclosure. Therefore, the terms used in the present disclosure may be defined based on the meaning of the term and the entire content throughout the present disclosure rather than the simple name of the term.

In the present disclosure, expressions such as “have”, “may have”, “include”, or “may include” may denote the existence of such characteristics (e.g., a numerical value, a function, an operation, and a component such as a part) and may not exclude the existence of additional characteristics.

The expression “at least one of A or B” should be interpreted to indicate any one of “A” or “B” or “A and B”.

The expression “1st”, “2nd”, “first”, “second”, or the like used in the present disclosure may be used to describe various elements regardless of any order and/or degree of importance, wherein such expression is used only to distinguish one element from another element and is not intended to limit the relevant element.

The description that one element (e.g., a first component) is “(operatively or communicatively) coupled with/to” or “connected to” another element (e.g., a second component) should be interpreted such that the one element may be directly coupled to the another element or the one element may be coupled to the another element through the other element (e.g., a third component).

A singular expression includes a plural expression, unless obviously differently defined in the context. In the application, the term such as “include” or “consist of” should be construed as designating that there are such characteristics, numbers, steps, operations, components, parts, or a combination thereof described in the present disclosure but not as excluding in advance possibility of the existence or addition of one or more other characteristics, numbers, steps, operations, components, parts, or a combination thereof.

In the present disclosure, “module” or “part” may perform at least one function or operation and may be implemented as hardware or software, or as a combination of hardware and software. In addition, a plurality of “modules” or “parts” may be integrated into at least one module and implemented as at least one processor excluding a “module” or a “part” that needs to be implemented as specific hardware.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

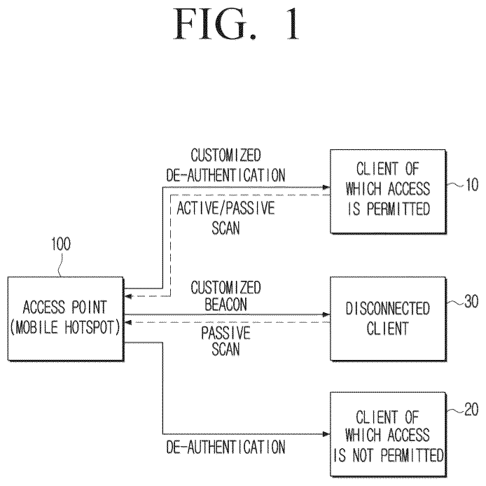

FIG. 1 is a view schematically illustrating an aspect of the present disclosure, according to an embodiment.

According to FIG. 1, an electronic device 100 may be a host device which may operate with an access point (AP) and/or may support mobile hotspot sharing. A client device (e.g., a first client device 10, a second client device 20, or a third client device 30) may be and/or may include an Internet of Things (IoT) device supporting a wireless-fidelity (Wi-Fi, or Institute of Electrical and Electronic Engineers (IEEE) 802.11) module. The Wi-Fi module may include Wi-Fi firmware and/or a Wi-Fi driver which may recognize the relevant Wi-Fi firmware in an operating system of the electronic device 100. Here, the Wi-Fi firmware (or a wireless LAN card) may be and/or may include hardware (e.g., electrical circuits, processing devices, or the like) and may be mounted in a body of the first to third client devices 10 to 30 and/or be mounted in the first to third client devices 10 to 30 by using an interface (e.g., an universal serial bus (USB) interface). For example, the Wi-Fi firmware may be implemented in at least one of a peripheral component interconnect (PCI) method, a PCI-Express method, a personal computer memory card international association (PCMCIA) method, a USB method, or the like.

The first to third client devices 10 to 30 may include at least one of a smart television (TV), a smart phone, a tablet personal computer (PC), a mobile phone, a video phone, an e-book reader, a desktop PC, a laptop PC, a netbook computer, a game console, a workstation, a server, a personal digital assistant (PDA), a portable multimedia player (PMP), a Moving Picture Experts Group Phase 1 (MPEG-1) audio layer 3 (MP3) player, a medical device, a home appliance, a security device, a camera, a printer, a wearable device, or the like. For example, the first client device 10 may be and/or may include a connection device of which access to the AP is permitted, the second client device 20 may be and/or may include an access non-permission device, and the third client device 30 may be and/or may include a disconnected device of which access is permitted.

The Wi-Fi module may perform communication only within an adjacent area in a criterion of the AP positioned at a specific point, wherein a valid area where communication is possible around the AP may be referred to as a hotspot. The AP may be and/or may include a relay device helping Internet connection in order that the client device uses a wireless internet service. In general, the AP may be separate from a router in regard that it takes a role of a wireless hub without an IP sharing function but the AP may be also implemented as the router. According to an embodiment, the AP may be implemented as a wireless access point (WAP) using a relevant standard using Wi-Fi (or a Wireless LAN). In this case, the client device may perform communication with the AP through a Wi-Fi network.

According to an embodiment, the electronic device 100, if a hotspot configuration change event is detected, may transmit a message to the first to third client devices 10 to 30 within the hotspot to automatically connect only the first and second client devices 10 and 20 of which access is permitted to the AP. The hotspot configuration change event may be an event in which at least one of a hotspot parameter or access permission client device information is changed. The message may include at least one of a customized de-authentication message, a customized beacon message, or a transmission control protocol (TCP)/user datagram protocol (UDP) message. For example, the electronic device may transmit the customized de-authentication message to the connected first client device 10 from among the first and second client devices 10 and 20 of which access is permitted, transmit the customized beacon message to the disconnected third client device 30, and transmit a de-authentication message to the second client device 20 of which access is not permitted.

If the first and second client devices 10 and 20 of which connection is permitted receives a message, it may update its configuration to a new configuration and then may be automatically connected to the electronic device 100 based on a passive scan and/or an active scan.

In the passive scan, the AP may transmit a beacon message (or a beacon frame) carrying a service set identifier (SSID) to a specific channel once every preset time period (e.g., about 100 milliseconds (ms)) to support connection, wherein the client device may proceed a connection process including authentication by receiving the beacon message while sequentially changing a channel (e.g., first to thirteen channels).

The active scan may be a method that if the client device receiving the customized de-authentication message sends a probe message, the AP receiving this message responds thereto. In this case, the customized de-authentication message may include at least one of SSID information, password information, band information, channel information, or reconfiguration timer information. For example, the customized de-authentication message may include all of this information.

Hereinafter, with reference to drawings, described are various embodiments that all client devices of which access is permitted are automatically connected to the AP according to an event that a hotspot configuration is changed.

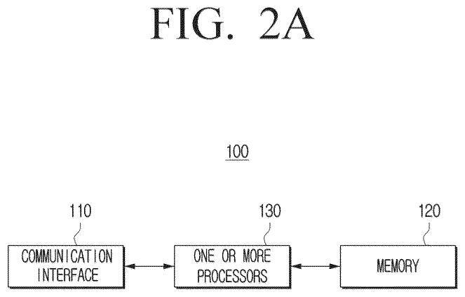

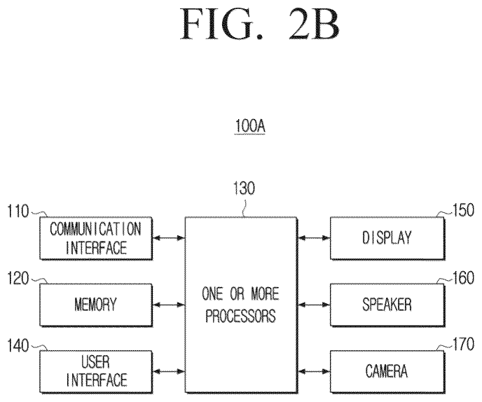

FIG. 2A is a block diagram illustrating a configuration of an electronic device, according to an embodiment.

According to FIG. 2A, an electronic device 100 includes a communication interface 110, memory 120, and one or more processors 130.

The electronic device 100 may be a host device which operates with an access point (AP) or supports mobile hotspot sharing. The electronic device 100 may be implemented as various types of devices which may perform functions of not only an AP device but also an AP and/or mobile hotspot sharing. For example, the electronic device 100 may be implemented as various devices such as, but not limited to, a TV, a smart phone, a mobile phone, a tablet, a navigation, a Portable Media Player (PMP), a game console, and a home appliance. Hereinafter, for convenience of the description, the description is made under the assumption that the electronic device 100 is implemented as a smart phone.

The communication interface 110 may perform communication with an external device. The communication interface 110 may be implemented to support a communication method of AP-based Wi-Fi (e.g., a wireless local area network (LAN) network). However, the present disclosure is not limited thereto and the communication interface 110 may further include a communication module supporting a communication method such as Bluetooth™ Zigbee, a wired/wireless local area network (LAN), a wide area network (WAN), Ethernet, IEEE 1394 (FireWire), a mobile high-definition link (MHL), Audio Engineering Society/European Broadcasting Union (AES/EBU), an optical communication method, a coaxial communication method, or the like.

The memory 120 is electrically connected to the one or more processors 130 and data required for various embodiments of the present disclosure may be stored. The memory 120 may be implemented as memory embedded in an electronic device 100 according to a use for data storage or may be implemented as memory detachable from the electronic device 100. For example, data for driving the electronic device 100 is stored in memory embedded in the electronic device 100 and data for an extension function of the electronic device 100 may be stored in memory detachable from the electronic device 100. In an embodiment, memory embedded in the electronic device 100 may be implemented as at least one of volatile memory (e.g., dynamic RAM (DRAM), static RAM (SRAM), synchronous dynamic RAM (SDRAM), or the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash memory, NOR flash memory, or the like), a hard drive, or a solid state drive(SSD)). Also, memory detachable from the electronic device 100 may be implemented as a memory card (e.g., a Compact Flash (CF) card, a Secure Digital (SD) card, a Micro Secure Digital (Micro-SD) card, a Mini Secure Digital (Mini-SD) card, an extreme Digital (xD) card, a Multi-Media Card (MMC), or the like), external memory connectable to a USB port (e.g., USB memory), or the like.

According to an embodiment, the memory 120 may store a computer program including at least one instruction or instructions for controlling the electric device 100.

According to an embodiment, the memory 120 may store access permission client device information, for example, a list including identification information of a client device of which access to the AP is permitted, hotspot configuration information of the AP, for example, hotspot parameter information, or the like.

According to an embodiment, the memory 120 may be implemented as single memory storing data generated from various operations, according to the present disclosure. According to another embodiment, the memory 120 may be implemented to include a plurality of memory storing each different type of data or storing each data generated from different steps.

In the aforementioned embodiment, it is described that various data is stored in the external memory 120 of the processor 130 but at least part of the data may be stored in memory inside the processor 130, according to at least one embodiment among the electronic device 100 or the one or more processors 130.

The one or more processors 130 may perform operations of the electronic device 100 according to various embodiments by executing at least one instruction stored in the memory 120.

The one or more processors 130 controls operations of the electronic device 100 overall. For example, the processor 130 may be connected to each component of the electronic device 100 to control operations of the electronic device 100 overall. For example, the processor 130 may be electrically connected to the display 150 and memory 120 to control the operations of the electronic device 100 overall. The processor 130 may be configured of one processor or a plurality of processors.

The one or more processors 130 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 130 may control one or any combination of other components of the electronic device and perform an operation related to communication or data processing. The one or more processors 130 may perform one or more programs or instructions stored in the memory. For example, the one or more processors may perform a method, according to an embodiment of the present disclosure, by executing one or more instructions stored in the memory.

If a method, according to an embodiment, includes a plurality of operations, the plurality of operations may be performed by one processor and may be performed by a plurality of processors. For example, when a first operation, a second operation, and a third operation are performed by a method, according to an embodiment, all of the first operation, the second operation, and the third operation may be performed by a first processor and also, the first operation and the second operation are performed by the first processor (e.g., a general purpose processor) and the third operation may be performed by the second processor (e.g., an Artificial Intelligence (AI)-dedicated processor).

The one or more processors 130 may be implemented as a single core processor including one core and may be implemented as one or more multi core processors including a plurality of cores (e.g., homogeneous multicores or heterogeneous multicores). If the one or more processors 130 are implemented as a multi core processor, each of the plurality of cores included in the multi core processor may include processor internal memory such as cache memory and on-chip memory, wherein a common cache shared by the plurality of cores may be included in the multi core processor. Also, each of the plurality of cores included in the multi core processor (or part of the plurality of cores) may read and perform program instructions for independently implementing a method, according to an embodiment of the present disclosure, and also, may read and perform program instructions for implementing a method, according to an embodiment of the present disclosure in connection with all (or part) of the plurality of cores.

If a method, according to an embodiment, includes a plurality of operations, the plurality of operations may be performed by one core among the plurality of cores included in the multi core processor and may be performed by the plurality of cores. For example, when a first operation, a second operation, and a third operation are performed by a method, according to an embodiment, all of the first operation, the second operation, and the third operation may be performed by a first core included in the multi core processor and also, the first operation and the second operation may be performed by the first core included in the multi core processor and the third operation may be performed by the second core included in the multi core processor.

In embodiments of the present disclosure, a processor may mean a System on Chip (SoC) onto which one or more processors and other electronic components are integrated, a single core processor, a multi core processor, or a core included in the single core processor or the multi core processor, wherein the core may be implemented as a CPU, a GPU, an APU, a MIC, a DSP, a NPU, a hardware accelerator, or a machine learning accelerator but embodiments of the present disclosure are not limited thereto.

The one or more processors 130 may be referred to as a processor 130 for convenience of the description.

FIG. 2B is a view illustrating a detailed configuration of an example of an electronic device, according to an embodiment.

According to FIG. 2B, the electronic device 100A may include a communication interface 110, memory 120, one or more processors 130, a user interface 140, a display 150, a speaker 160, and a camera 170. The detailed description of components overlapped with the components shown in FIG. 2A among the components shown in FIG. 2B is omitted.

The user interface 140 may be implemented as a device such as a button, a touch pad, a mouse, and a keyboard or may be implemented as a touch screen capable of performing the aforementioned display function and also the manipulation input function together. According to an embodiment, the user interface 140 may be implemented as a transceiver of a remote controller and may receive a remote control signal. The transceiver of the remote controller may receive a remote signal or transmit the remote signal from/to an external remote control device through at least one communication method of an infrared communication method, a Bluetooth communication method, or a Wi-Fi communication method.

The display 150 may be implemented as a display including a spontaneous emission element or a display including a non-spontaneous emission element, and backlight. For example, it may be implemented as various types of displays such as, but not limited to, a liquid crystal display (LCD), an organic light emitting diode (OLED) display, a light emitting diode (LED), a micro LED, a mini LED, a plasma display panel (PDP), a quantum dot (QD) display, and a quantum dot light-emitting diode (QLED). The display 110 may include a driving circuit which may be implemented in a form such as an amorphous silicon (a-si) thin film transistor (TFT), a low temperature poly silicon (LTPS) TFT, or an organic TFT (OTFT), a backlight unit, or the like. In an embodiment, the display 110 may be implemented as a flexible display, a rollable display, a three-dimensional (3D) display, a display in which a plurality of display modules are physically connected, or the like. According to an embodiment, the processor 130, if the hotspot parameter is changed, may provide a UI for updating the access permission client device information through the display 150 and update the access permission client device information based on a user command received from the UI.

The speaker 160 may output audio data. For example, the speaker 160 may convert the digital audio data processed in the one or more processors 130 to analog audio data and then amplify and output the converted analog audio data. For example, the speaker 160 may include at least one speaker unit capable of outputting at least one channel, a digital-to-analog (D/A) converter, an audio amplifier, or the like. According to an embodiment, the speaker 160 may be implemented to output various multichannel acoustic signals.

The camera 170 may be turned on according to a preset event and perform capturing. The camera 170 may convert the captured image to an electric signal and generate image data based on the converted signal. For example, a subject may be converted to an electric image signal through a semiconductor optical device, a charge coupled device (CCD), and the converted image signal as above may be amplified and converted to a digital signal and then may be signal processed.

The electronic device 100A may additionally include a tuner and a demodulator, according to an embodiment. The tuner may receive the radio frequency (RF) broadcasting signals by tuning a channel selected by the user among radio frequency (RF) broadcasting signals received through an antenna or all prestored channels. The demodulator may receive and demodulate a digital IF (DIF) signal converted in the tuner and may perform channel demodulation.

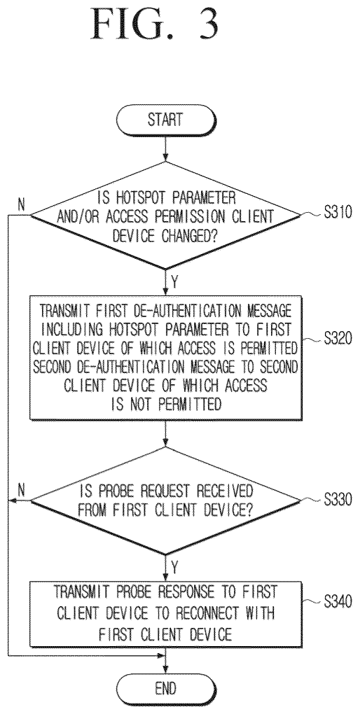

FIG. 3 is a view illustrating a communication connection method of an electronic device, according to an embodiment.

According to an embodiment, the processor 130, if the hotspot configuration information is changed, may perform reconnection with the existing connected first client device 10 through an active scan mode.

According to an embodiment, the processor 130 may identify whether at least one of a hotspot parameter or access permission client device information (hereinafter referred to as access permission device information) is changed or not (operation S310). The hotspot parameter may include at least one of SSID information, password information, band information, or channel information. The access permission device information may include a device list including identification information of a client of which access is permitted.

The processor 130, if identifying that the hotspot parameter and/or the access permission device information is changed (Y in operation S310), may transmit a first de-authentication message including the hotspot parameter to a first client device 10 of which access is permitted through the communication interface 110 and transmit a second de-authentication message to a second client device 20 of which access is not permitted (operation S320). According to an embodiment, both the first client device 10 and the second client device 20 are connected to the AP. However, the first client device 10 may be a device of which access is permitted and the second client device 20 may be a device of which access is not permitted according to the change of the hotspot parameter and/or the access permission client device information. The communication connection method may terminate if the hotspot parameter and/or the access permission device information have not change (N in operation S310).

According to an embodiment, the first de-authentication message may include a first reason code and the second de-authentication message may include a second reason code, the hotspot parameter, and reconfiguration timer information. A reconfiguration timer may include expected time information in order that the electronic device 100, that is, the host device resets a new access point or hotspot. For example, the second de-authentication message may be the customized de-authentication message described with reference to FIG. 1. According to an embodiment, if the hotspot parameter is changed, the second de-authentication message may include the changed hotspot parameter. According to an embodiment, if only the access permission client device is changed, the second de-authentication message may include the existing hotspot parameter.

The processor 130, if a probe request is received from the first client device (Y in operation S330), may transmit a probe response to the first client device to perform reconnection with the first client device (operation S340). According to an embodiment, the processor 130 may receive the probe request based on reconfiguration timer information from the first client device updated based on the hotspot parameter received from the electronic device 100. The communication connection method may terminate if the hotspot parameter and/or the access permission device information have not change (N in operation S330).

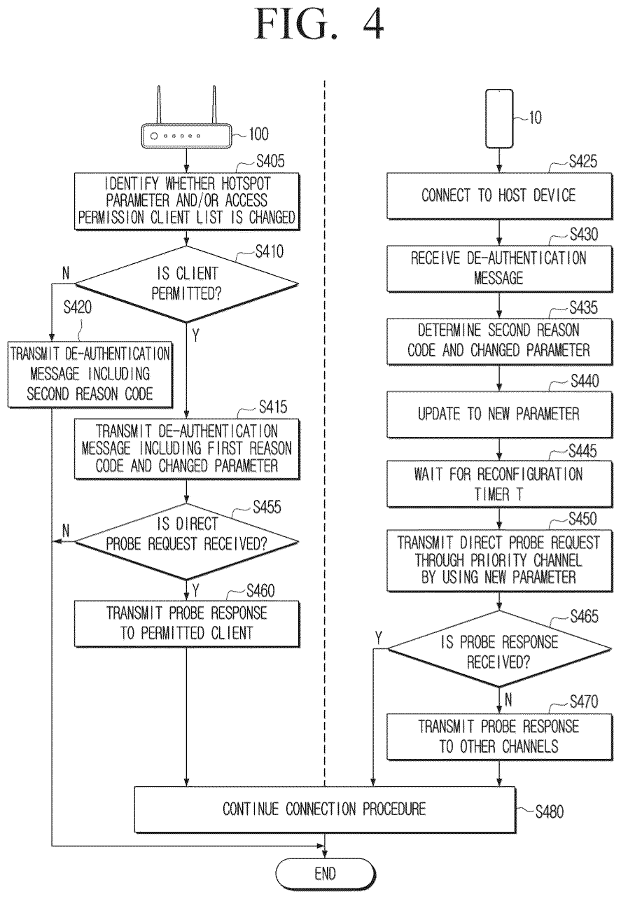

FIG. 4 is a sequence diagram illustrating a communication connection method between a host device and a client device, according to an embodiment.

According to an embodiment, the electronic device 100 (e.g., the host device), if the hotspot configuration information is changed, may automatically perform reconnection with the existing connected first client device 10 through an active scan mode.

According to FIG. 4, the electronic device 100, if identifying that the hotspot parameter and/or access permission device information (e.g., an access permission device list) is changed (operation S405), may identify whether each client device within the hotspot is a device of which access is permitted (operation S410). For example, the electronic device 100 may identify whether each client device is a device of which access is permitted based on the changed access permission client device list.

The electronic device 100 may transmit, in operation S415, a first de-authentication message including a first reason code, a reconfiguration timer T, or a hotspot parameter (e.g., a changed hotspot parameter) to the first client device 10 identified such that its access is permitted (Y in operation S410).

The electronic device 100 may transmit, in operation S420, a second de-authentication message including a second reason code to the second client device 20 identified such that its access is not permitted (N in operation S410).

The first de-authentication message and the second de-authentication message may be and/or may include unicast messages and may be transmitted only to a protected bearer. All of the client devices receiving the first de-authentication message and the second de-authentication message may be deactivated in connection with the electronic device 100 regardless of the reason code.

The first reason code and the second reason code may be one of reasons defined in an IEEE 802.11 telecommunication standard and/or may be a newly (e.g., custom) defined reason. For example, the first and second reason codes may be reason 0x007 (e.g., Class 3 frame received from non-associated STA) that may be defined in the IEEE 802.11 standard or may be newly defined reason 0x067 (e.g., de-authentication due to a change in an AP configuration). According to an embodiment, the first reason code and the second reason code may be identical.

In an embodiment, the first client device 10 of which access is permitted, in a state of being connected to the electronic device 100 (operation S425), if receiving the first de-authentication message (operation S430), may identify whether the first de-authentication message includes a first reason code, a reconfiguration timer T, and a hotspot parameter (e.g., a changed parameter) (operation S435).

The first client device 10 may update the prestored hotspot parameter to a new hotspot parameter identified in the operation S435 (operation S440) and may wait for the reconfiguration timer T (operation S445). The reconfiguration timer T may be expected time in order that the host device 100 resets a hotspot.

The first client device 10, if the reconfiguration timer T is passed, may transmit a probe request based on the updated hotspot parameter (operation S450). According to an embodiment, the first client device 10 may transmit the probe request through a priority channel and may wait for a probe response in the priority channel. For example, a direct probe request may be transmitted once and/or may be transmitted several times in the priority channel. According to an embodiment, to reduce a scan procedure, the priority channel may be determined according to the predefined rule. For example, if the channel parameter is not changed, the priority channel may be a previous channel connected to the electronic device 100, and if the channel parameter is changed, the priority channel may be a new value.

The electronic device 100, if the probe request is received from the first client device 10 (Y in operation S455), may transmit the probe response to the first client device 10 (operation S460). Alternatively, if the probe request is not received from the first client device 10 (N in operation S455), the communication connection method may terminate.

The first client device 10, if the probe response is received (Y in operation S465), may proceed a procedure for reconnection with the electronic device 100. In an embodiment, the first client device 10, if the probe response is not received from the channel to which the probe request is transmitted (N in operation S465), may transmit the probe request to the other channels (operation S470). For example, the first client device 10, if the probe response is not received from the priority channel, may transmit the probe request to the other channels to find other accessible host devices.

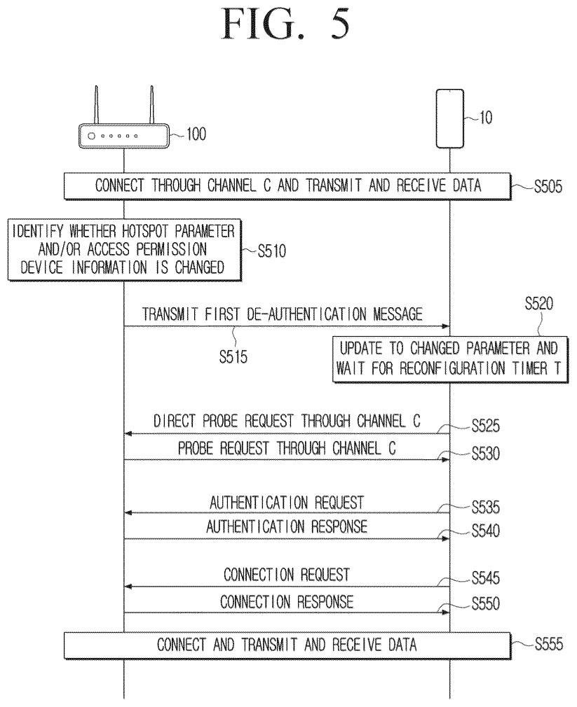

FIG. 5 is a sequence diagram illustrating a communication connection method between a host device and an access permission device, according to an embodiment.

FIG. 5 is a view specifically illustrating a communication reconnection method between the electronic device 100 and the first client device 10 shown in FIG. 1, wherein the partial description related to the overlapped content is omitted.

According to FIG. 5, the electronic device 100 may be connected to the first client device 10 through a channel C and may transmit and receive data (operation S505). The electronic device 100 and the first client device 10 may make a safe bearer by sharing a connection ID and/or may be protected by encryption using a shared key.

The electronic device 100, if identifying that the hotspot parameter and/or the access permission device information is changed (operation S510), may transmit the first de-authentication message to the first client device 10 (operation S515). The first de-authentication message is a unicast message and may be transmitted to a protected bearer.

The first de-authentication message may include a first reason code, a hotspot parameter (e.g., a changed hotspot parameter), and reconfiguration timer information. The hotspot parameter may include at least one of SSID information, password information, band information, or channel information.

The first client device 10, if the first de-authentication message is received, may update the existing hotspot parameter to the hotspot parameter included in the first de-authentication message and wait for the reconfiguration timer T based on the reconfiguration timer information (operation S520).

The first client device 10 may transmit a probe request to the electronic device 100 through the channel C after the reconfiguration timer T (operation S525). As an embodiment, the first client device 10 may transmit a direct probe request including the updated SSID to the electronic device 100 and may wait to receive the probe response in the channel C.

The electronic device 100, if the probe request is received through the channel C from the first client device 10, may transmit the probe response through the channel C (operation S530).

The first client device 10, if the probe response is received through the channel C, may transmit an authentication request (operation S535). The authentication request may include the updated password, that is, the password included in the first de-authentication message.

The electronic device 100 may transmit an authentication response to the authentication request transmitted from the first client device 10 to the first client device 10 (operation S540). As an example, the electronic device 100 may confirm the password included in the authentication request to transmit the authentication response.

The first client device 10, if the authentication response is received from the electronic device 100, may transmit a connection request (e.g., an association request) (operation S545). The electronic device 100 receiving the connection request may transmit a connection response (e.g., an association response) to the first client device 10 (operation S550).

If the first client device 10 receives the connection response, communication between the electronic device 100 and the first client device 10 may be reconnected (operation S555).

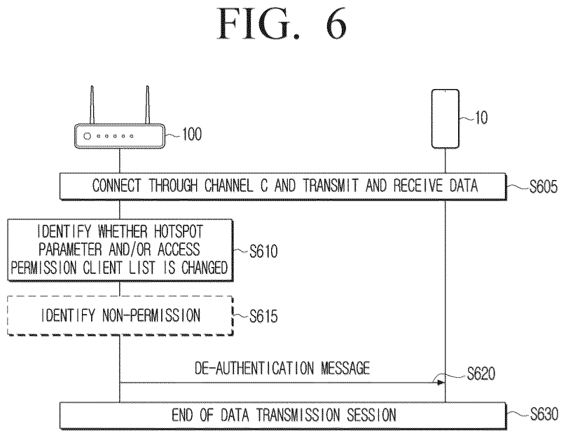

FIG. 6 is a sequence diagram illustrating a communication method between a host device and an access non-permission client device, according to an embodiment.

FIG. 6 is a view specifically illustrating a communication method between the electronic device 100 and the second client device 20 shown in FIG. 1, wherein a partial description related to an overlapped content is omitted.

According to an embodiment, if the second client device 20 is not included in the access permission client device list or the electronic device 100 tries to remove the second client device 20 from the access permission client device list, the electronic device 100 may transmit the second de-authentication message including a second reason code.

For example, according to FIG. 6, the electronic device 100, while being connected to the second client device 20 through the channel C and transmitting and receiving data (operation S605), if identifying that a hotspot parameter and/or access permission device information is changed (operation S610), may identify whether the second client device 20 is an access permission device (operation S615).

The electronic device, if identifying that the second client device 20 is not an access permission device, may transmit the second de-authentication message to the second client device 20 (operation S620). Here, the second de-authentication message may include a second reason code. The second reason code is decoded as “Unknown” in the second client device 20 and connection between the electronic device 100 and the second client device 20 may be disconnected (operation S630).

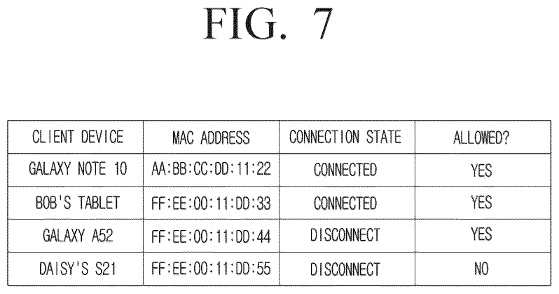

FIG. 7 is a view illustrating an example of an access permission device list, according to an embodiment.

According to an embodiment, each AP and/or the mobile hotspot, for example, a client device database including all of a client device connected to the electronic device 100 and a client device disconnected thereto may be stored. For example, as shown in FIG. 7, the database may store device identification information (e.g., a device name), an MAC address, a connection state, and information about whether access is allowed.

According to an embodiment, in case that the hotspot parameter is changed, if a user selects or removes a device of which reconnection is allowed, the relevant device may be added to or removed from the access permission device list. In an embodiment, if the user does not change the access permission device, the access permission device list may be maintained without any change.

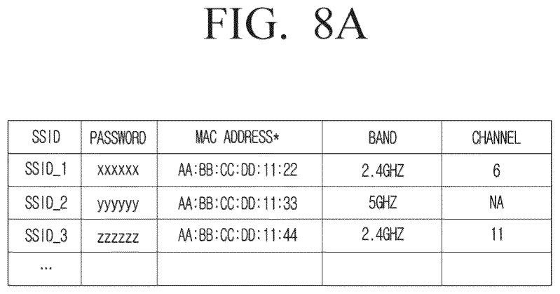

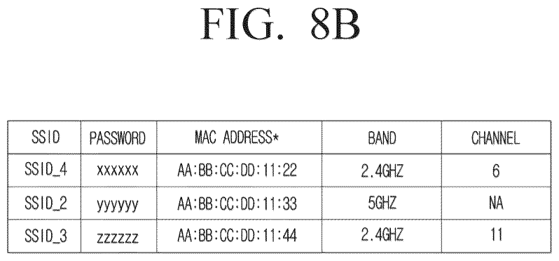

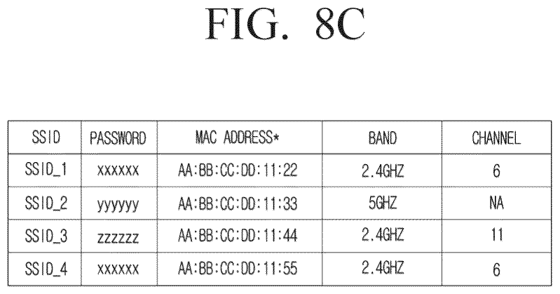

FIGS. 8A to 8C are views illustrating data used for communication connection, according to an embodiment.

FIG. 8A may show an AP database, according to an embodiment. The AP database may be and/or may include data used by each client device to be connected to an AP and may be stored in each client device.

In FIG. 8A, if the MAC address is an MAC address of the client device and a type of MAC address is a randomized MAC, an MAC address used by the client device may be arbitrarily generated whenever the client device is connected to the AP.

According to an embodiment, it may be assumed that the data shown in FIG. 8A is an AP database of the first client device 10 and the first client device 10 receives a first de-authentication message including the first reason code and the changed hotspot parameter.

For example, if one of the changed hotspot parameters is SSID, for example, if SSID_1 is changed to SSID_4, the AP database shown in FIG. 8A may be updated as shown in FIG. 8B. Otherwise, if SSID_4 is newly generated, the AP database shown in FIG. 8A may be updated as shown in FIG. 8C. For example, as shown in FIG. 8C, the MAC address of the first client device 10 corresponding to SSID_4 may be randomly generated.

In an embodiment, if one of the changed hotspot parameters is one of a password or a channel, the relevant information may be simply updated.

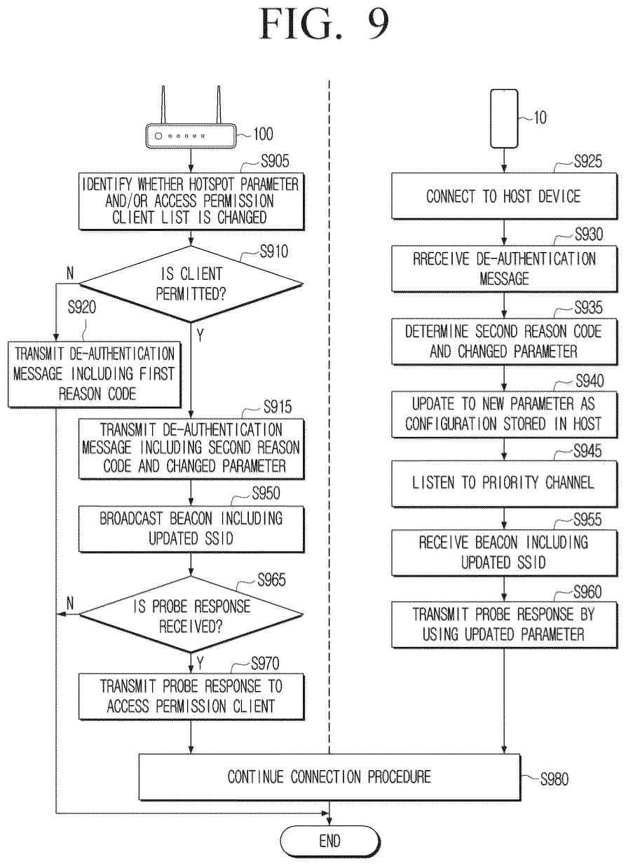

FIG. 9 is a sequence diagram illustrating a communication connection method between a host device and a client device, according to an embodiment.

According to an embodiment, the electronic device 100 (e.g., the host device), if the hotspot configuration information is changed, may automatically perform reconnection with the existing connected client device 10 through a passive scan mode. The detailed description of an operation that is the same as or similar to the operation using the active scan mode among each operation shown in FIG. 9 is omitted.

According to FIG. 9, the electronic device 100, if identifying that the hotspot parameter and/or access permission device information (an access permission device list) is changed (operation S905), may identify whether each client device within the hotspot is a device of which access is permitted (operation S910). For example, the electronic device 100 may identify whether each client device is a device of which access is permitted based on the changed access permission client device list.

The electronic device 100 may transmit, in operation S915, a first de-authentication message including a first reason code and a hotspot parameter (e.g., a changed hotspot parameter) to the first client device 10 identified such that its access is permitted (Y in operation S910).

The electronic device 100 may transmit, in operation S920, a second de-authentication message including a second reason code to the second client device 20 identified such that its access is not permitted (N in operation S910).

The first de-authentication message and the second de-authentication message are unicast messages and may be transmitted only to a protected bearer. All of the client devices receiving the first de-authentication message and the second de-authentication message may be deactivated in connection with the electronic device 100 regardless of the reason code.

The first reason code and the second reason code may be one of reasons defined in an IEEE 802.11 telecommunication standard and/or may be a newly defined reason. For example, the first and second reason codes may be reason 0x007 (e.g., Class 3 frame received from non-associated STA) defined in an IEEE 802.11 telecommunication standard or may be a newly defined reason 0x067 (e.g., de-authentication due to a change in an AP configuration). According to an embodiment, the first reason code and the second reason code may be identical.

In an embodiment, the first client device 10 of which access is permitted, in a state of being connected to the electronic device 100 (operation S925), if receiving the first de-authentication message (operation S930), may identify whether the first de-authentication message includes a first reason code and a hotspot parameter (e.g., a changed parameter) (operation S935).

The first client device 10 may update the prestored hotspot parameter to a new hotspot parameter identified in the operation S935 (operation S940) and may start to listen to a priority channel (operation S945).

The electronic device 100 may broadcast a beacon (or a beacon message) including the updated SSID (operation S950).

The first client device 10, if receiving the beacon including the updated SSID through the priority channel (operation S955), may transmit a probe request by using the updated hotspot parameter (operation S960).

The electronic device 100, if receiving the probe request from the first client device 10 (Y in operation S965), may transmit the probe response to the first client device 10 (operation S970), and the first client device 10, if receiving the probe response, may proceed a procedure for reconnection with the electronic device 100 (operation S980). Alternatively, if the probe request is not received (N in operation S965), the communication connection method may be terminated.

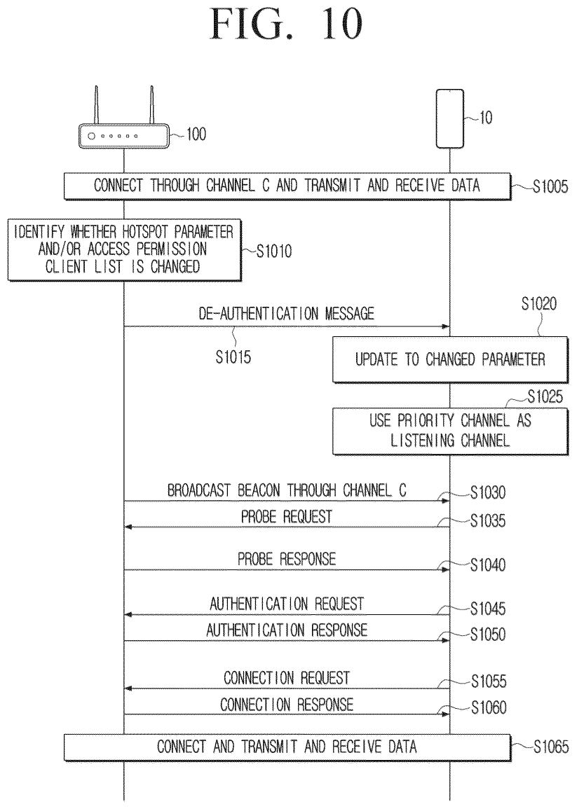

FIG. 10 is a sequence diagram illustrating a communication connection method between a host device and an access permission device, according to an embodiment.

FIG. 10 is a view specifically illustrating a communication reconnection method between the electronic device 100 and the first client device 10 shown in FIG. 9, wherein the partial description related to the overlapped content is omitted.

According to FIG. 10, the electronic device 100 may be connected to the first client device 10 through a channel C and may transmit and receive data (operation S1005). The electronic device 100 and the first client device 10 may make a safe bearer by sharing a connection ID and be protected by encryption using a shared key.

The electronic device 100, if identifying that the hotspot parameter and/or the access permission device information is changed (operation S1010), may transmit the first de-authentication message to the first client device 10 (operation S1015). The first de-authentication message is a unicast message and may be transmitted to a protected bearer. Here, the first de-authentication message may include a first reason code and a hotspot parameter (e.g., a changed hotspot parameter).

The first client device 10, if the first de-authentication message is received, may update the existing hotspot parameter to the hotspot parameter included in the first de-authentication message (operation S1020) and may identify the channel C as the priority channel and may start to listen to the channel C (operation S1025).

The electronic device 100 may broadcast a beacon through the channel C (S1030). Here, the beacon may include the updated hotspot parameter.

The first client device 10 may receive the beacon based on the updated hotspot parameter and thus, may transmit a probe request to the electronic device 100 (operation S1035). According to an embodiment, the SSID included the probe request may be the updated SSID.

The electronic device 100, if the probe request is received through the channel C from the first client device 10, may transmit the probe response through the channel C (operation S1040).

The first client device 10, if the probe response is received through the channel C, may transmit an authentication request (operation S1045). Here, the authentication request may include the updated password, that is, the password included in the first de-authentication message.

The electronic device 100 may transmit an authentication response to the authentication request transmitted from the first client device 10 to the first client device 10 (S1050).

The first client device 10, if the authentication response is received from the electronic device 100, may transmit a connection request (operation S1055). The electronic device 100 receiving the connection request may transmit a connection response to the first client device 10 (S1060).

If the first client device 10 receives the connection response, communication between the electronic device 100 and the first client device 10 may be reconnected (operation S1065).

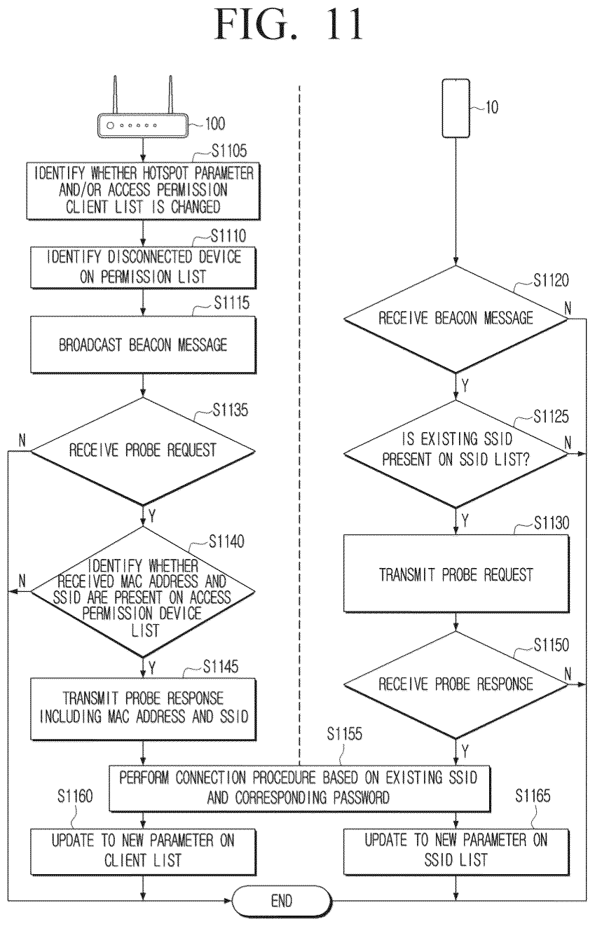

FIG. 11 is a sequence diagram illustrating a communication connection method between a host device and a client device, according to an embodiment.

According to an embodiment, the electronic device 100 (e.g., the host device), if the hotspot configuration information is changed, may perform reconnection with the disconnected device. In each step shown in FIG. 11, the detailed description of the step that is the same as or similar to the step included in FIGS. 4 and 9 is omitted.

According to FIG. 11, the electronic device 100, if identifying that the hotspot parameter and/or access permission device list is changed (operation S1105), may identify whether a disconnected device is present on the access permission device list (operation S1110). For example, the electronic device 100 may identify a device present in a disconnected state based on information about a connection state in the data shown in FIG. 7.

If the disconnected device is present on the access permission device list, the electronic device 100 may broadcast a beacon message including at least one SSID (e.g., a new SSID and the existing SSID) (operation S1115). According to an embodiment, if the SSID is not changed, the new SSID and the existing SSID may be identical.

The third client device 30, if a beacon message including at least one SSID (e.g., the new SSID and the existing SSID) is received (Y in operation S1120), may identify whether the existing SSID included in the beacon message is present on the SSID list (operation S1125). Alternatively, the communication connection method may terminate if the beacon message is not received (N in operation S1120).

The third client device 30, if the existing SSID included in the beacon message is present on the SSID list (Y in operation S1125), may transmit a probe request including an MAC address and an SSID corresponding to the existing SSID based on the SSID list (operation S1130). Alternatively, the communication connection method may terminate if the existing SSID included in the beacon message is not present on the SSID list (N in operation S1125).

The electronic device 100, if the probe request including the MAC address and the SSID is received (Y in operation S1135), may identify whether the received MAC address and SSID are present on the access permission device list (S1140). Alternatively, the communication connection method may terminate if the probe request is not received (N in operation S1135).

The electronic device 100, if identifying that the received MAC address and SSID are present on the access permission device list (Y in operation S1140), may transmit the probe response including the identified MAC address and SSID to the third client device 30 (operation S1145). Alternatively, the communication connection method may terminate if the received MAC address and SSID are not present on the access permission device list (N in operation S1140).

The third client device 30, if the probe response is received (Y in operation S1150), may perform a connection procedure based on the existing SSID and the corresponding password (operation S1155). Alternatively, the communication connection method may terminate if the probe response is not received (N in operation S1150).

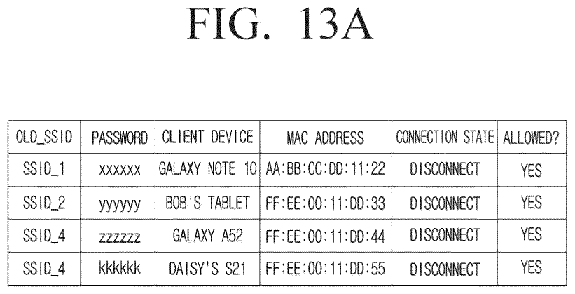

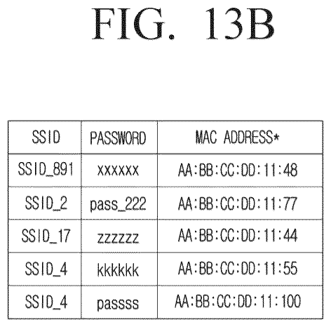

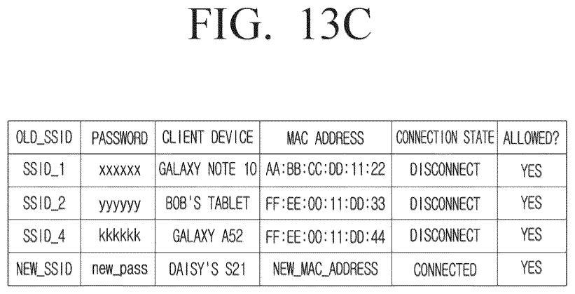

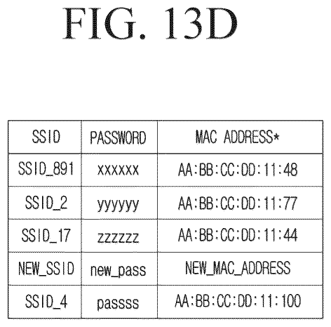

The electronic device 100 may update the parameter to a new parameter on the client device list (operation S1160). With respect to the above, the description is made with reference to FIG. 13C.

The third client device 30 may update the parameter to a new parameter on the SSID list (operation S1165). With respect to the above, the description is made with reference to FIG. 13D.

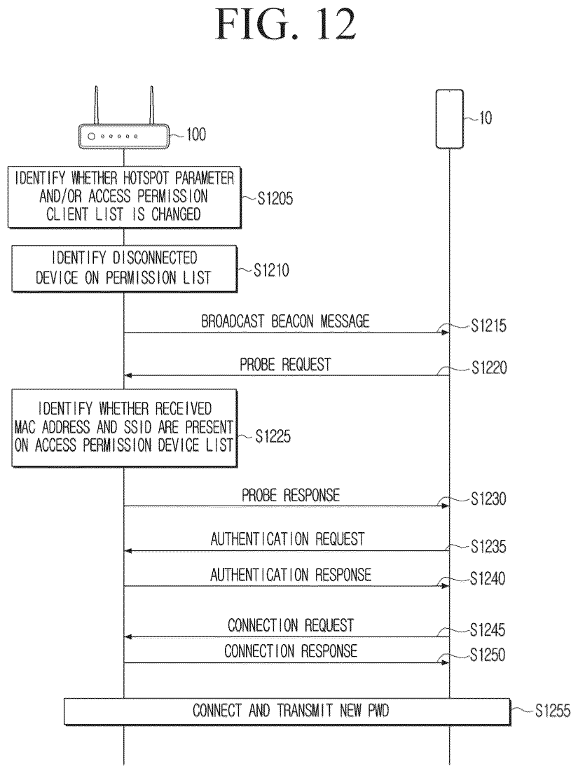

FIG. 12 and FIGS. 13A to 13D are views illustrating a communication connection method between a host device and a client device, according to an embodiment.

FIG. 12 is a view specifically illustrating a communication connection method between the electronic device 100 and the third client device 30 shown in FIG. 11, wherein the partial description related to the overlapped content is omitted.

According to FIG. 12, the electronic device 100 may be in a state that its communication with the third client device 30 is disconnected.

The electronic device 100, if identifying that the hotspot parameter and/or the access permission device information is changed (operation S1205), may identify whether a disconnected device is present on the access permission device list (operation S1210). For example, the electronic device 100 may identify a device present in a disconnected state based on information about a connection state in the data shown in FIG. 7.

If the disconnected device is present on the access permission device list, the electronic device 100 may broadcast a beacon message including at least one SSID (e.g., a new SSID and the existing SSID) (operation S1215). According to an embodiment, if the SSID is not changed, the new SSID and the existing SSID may be identical.

According to an embodiment, it may be assumed that information about the disconnected device of which access is permitted is stored in the electronic device 100 as shown in FIG. 13A. For example, if a current SSID of the electronic device 100 is new_SSID, the electronic device 100 may broadcast a beacon message including (e.g., new_SSID, SSID_1, SSID_2, SSID_4). According to an embodiment, an option defining the existing SSID in the database and/or the beacon message of the electronic device 100 may be various. For example, the number of the existing SSID stored in the database of the electronic device 100 may be limited to the preset number N and the beacon message may include the existing SSID of the maximum number N. According to an embodiment, the time limit for storing the existing SSID may be the preset time T. That is, if the time T is passed after the existing SSID is stored in the database of the electronic device 100, the relevant SSID may be automatically removed.

The third client device 30, if the beacon message including at least one SSID (e.g., a new SSID and the existing SSID) is received, may identify whether the existing SSID included in the beacon message is present on the SSID list and may transmit a probe request including an MAC address and an SSID corresponding to the existing SSID based on the SSID list (operation S1220). The beacon message is broadcast and thus all client devices may receive and compare the beacon message with the prestored existing SSID. According to an embodiment, the third client device 30 may store the always connected hotspot and/or identification information of the AP and the MAC address used for connecting to the relevant hotspot and/or AP as shown in FIG. 13B. In this case, the third client device 30 may transmit the probe request including (e.g., [AA:BB:CC:DD:11:33, SSID_2]; [AA:BB:CC:DD:11:55, SSID_4]; [AA:BB:CC:DD:11:100, SSID_4]).

The electronic device 100, if the probe request including the MAC address and the SSID is received, may identify whether the received MAC address and SSID are present on the access permission device list (operation S1225). The electronic device 100, if identifying that the received MAC address and SSID are present on the access permission device list, may transmit the probe response including the identified MAC address and SSID to the third client device 30 (operation S1230). For example, the electronic device 100 may identify information (AA:BB:CC:DD:11:55, SSID_4) included in the probe request and transmit the probe response including the identified SSID and the corresponding MAC address (AA:BB:CC:DD:11:55, SSID_4) to the third client device 30.

The third client device 30, if the probe response is received, may transmit an authentication request to the electronic device 100 (operation S1235). For example, the third client device 30 may transmit the authentication request based on the existing SSID and the corresponding password.

The electronic device 100, if the authentication request is received from the third client device 30, may transmit an authentication response to the authentication request to the third client device 30 (operation S1240).

The third client device 30, if the authentication response is received from the electronic device 100, may transmit a connection request (operation S1245). The electronic device 100 receiving the connection request may transmit a connection response to the third client device 30 (operation S1250).

If the third client device 30 receives the connection response, communication between the electronic device 100 and the third client device 30 may be reconnected (operation S1255). In this case, the electronic device 100 may transmit a password corresponding to the new SSID to the third client device 30.

In an embodiment, after authentication and reconnection of the third client device 30, the table shown in FIG. 13A stored in the electronic device 100 may be updated as shown in FIG. 13C. That is, information of Daisy's S21 may be updated as shown in FIG. 13C. Also, the table shown in FIG. 13B stored in the third client device 30 may be updated as shown in FIG. 13D. That is, a new hotspot and/or information of the AP may be updated as shown in FIG. 13D.

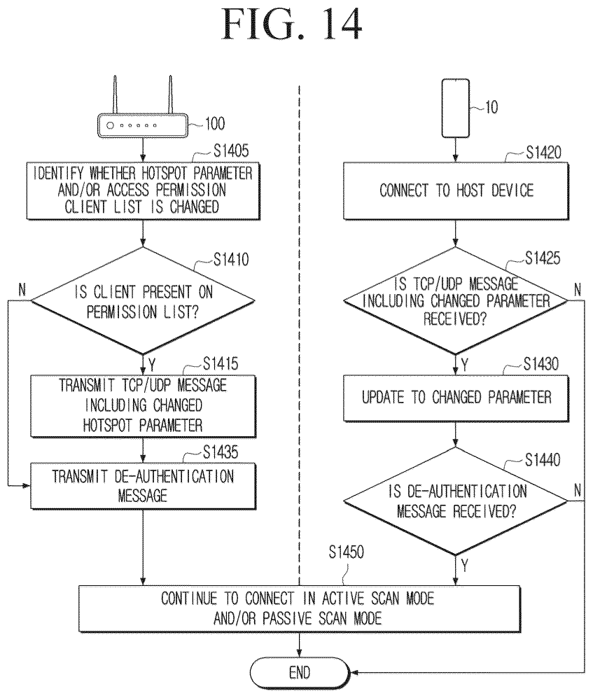

FIG. 14 is a view illustrating a communication connection method between a host device and a client device, according to an embodiment.

According to an embodiment, the electronic device 100 (e.g., the host device), if the hotspot configuration information is changed, may automatically perform reconnection with the existing connected client device 10 by using a TCP/UDP message.

According to FIG. 14, the electronic device 100, if identifying that the hotspot parameter and/or access permission device information (an access permission device list) is changed (operation S1405), may identify whether each client device within the hotspot is a device of which access is permitted (operation S1410). For example, the electronic device 100 may identify whether each client device is a device of which access is permitted based on the changed access permission client device list.

The electronic device 100 may transmit, in operation S1415, the TCP/UDP message including the changed hotspot parameter to the first client device 10 identified such that its access is permitted (Y in operation S1410). That is, the electronic device 100 may transmit the TCP/UDP message including the changed hotspot parameter instead of the first de-authentication message (the customized de-authentication message). Alternatively, if the first client device 10 is not present on the permission list (N in operation S1410), the communication connection method may proceed to operation S1435.

The first client device 10, in a state in connection with the electronic device 100 (operation S1420), if the TCP/UDP message is received (Y in operation S1425), may update the prestored hotspot parameter to the hotspot parameter included in the TCP/UDP message (S1430). Alternatively, the communication connection method may terminate if the TCP/UDP message is not received (N in operation S1425).

The electronic device 100 may transmit the de-authentication message (operation S1435) and the first client device 10 may receive the de-authentication message (operation S1440). If the first client device 10 receives the de-authentication message (Y in operation S1440), the electronic device 100 and the first client device 10 may continue to connect in active scan mode and/or passive scan mode (operation S1450). Alternatively, the communication connection method may terminate if the first client device 10 does not receive the de-authentication message (N in operation S1440).

According to the aforementioned embodiment, the electronic device 100 may transmit the TCP/UDP message including the changed hotspot parameter instead of the first de-authentication message (e.g., the customized de-authentication message), transmit a normal de-authentication message for disconnection, and then perform reconnection. Thereafter, the reconnection procedure may be the same as or similar to the reconnection procedure in the active scan mode and/or passive scan mode described in FIGS. 4 and 9 (operation S1450).

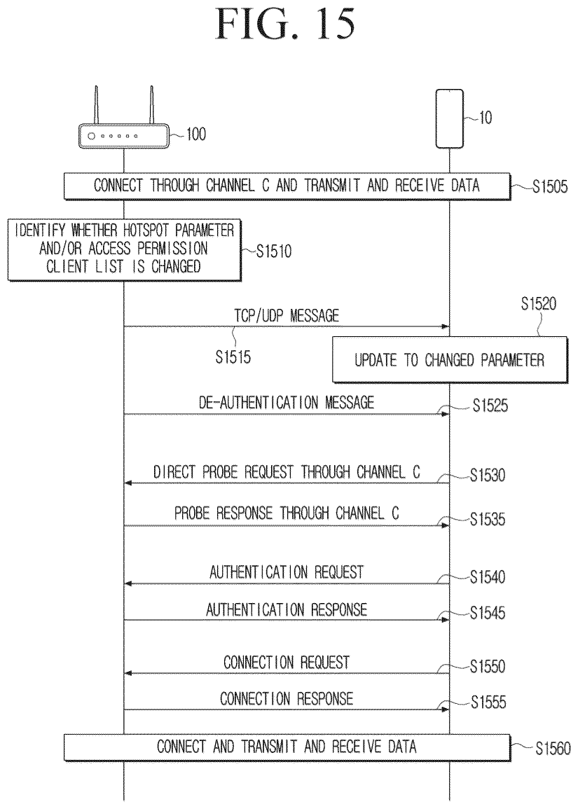

FIG. 15 is a sequence diagram illustrating a communication connection method between a host device and a client device, according to an embodiment.

FIG. 15 is a view illustrating a method of performing a communication reconnection method using the TCP/UDP message described in FIG. 14 through an active scan mode.

According to an embodiment, the electronic device 100, if the hotspot configuration information is changed, may perform reconnection with the existing connected first client device 10 through the TCP/UDP message and the active scan.

According to FIG. 15, the electronic device 100 may be connected with the first client device 10 through a channel C and may transmit and receive data (operation S1505). The electronic device 100 and the first client device 10 may make a safe bearer by sharing a connection ID and be protected by encryption using a shared key.

The electronic device 100, if identifying that the hotspot parameter and/or the access permission device information is changed (operation S1510), may transmit the TCP/UDP message to the first client device 10 (operation S1515). The TCP/UDP message is a unicast message and may include the changed hotspot parameter.

The first client device 10, if the TCP/UDP message is received, may update the existing hotspot parameter to the changed hotspot parameter (operation S1520).

Thereafter, the electronic device 100 may transmit the de-authentication message to the first client device 10 (operation S1525) and communication connection between the electronic device 100 and the first client device 10 may be disconnected.

The first client device 10 may transmit a direct probe request including the updated SSID to the electronic device 100 (operation S1530) and may wait to receive the probe response in the channel C.

The electronic device 100, if the probe request is received through the channel C from the first client device 10, may transmit the probe response through the channel C (operation S1535).

The first client device 10, if the probe response is received through the channel C, may transmit an authentication request (operation S1540). Here, the authentication request may include the updated password, that is, the changed password included in the TCP/UDP message.

The electronic device 100 may transmit an authentication response to the authentication request to the first client device 10 (operation S1545). As an example, the electronic device 100 may confirm the password included in the authentication request to transmit the authentication response.

The first client device 10, if the authentication response is received from the electronic device 100, may transmit a connection request (operation S1550). The electronic device 100 receiving the connection request may transmit a connection response to the first client device 10 (operation S1555).

If the first client device 10 receives the connection response, communication between the electronic device 100 and the first client device 10 may be reconnected (operation S1560).

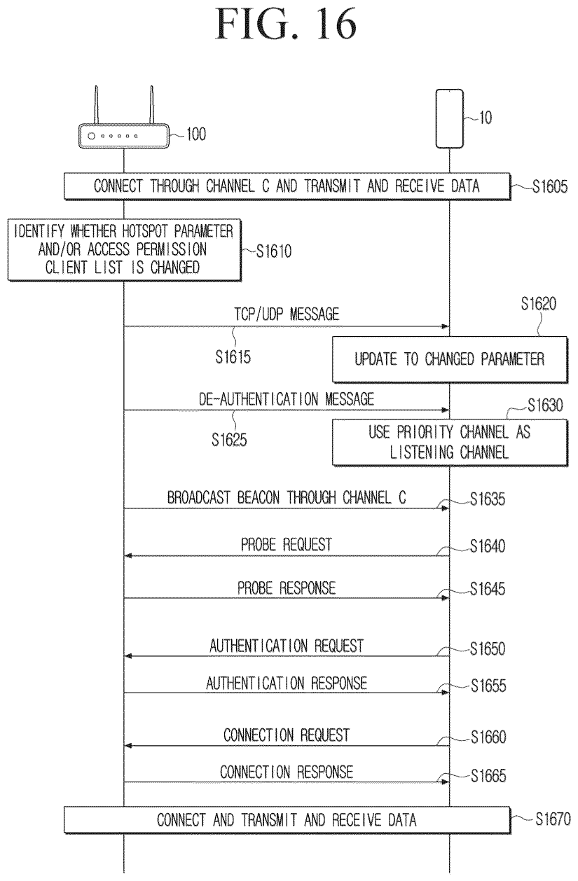

FIG. 16 is a sequence diagram illustrating a communication connection method between a host device and a client device, according to an embodiment.

FIG. 16 is a view illustrating a method of performing a communication reconnection method using the TCP/UDP message described in FIG. 14 through a passive scan mode.

According to an embodiment, the electronic device 100, if the hotspot configuration information is changed, may perform reconnection with the existing connected first client device 10 through the TCP/UDP message and the passive scan.

According to FIG. 16, the electronic device 100 may be connected with the first client device 10 through a channel C and may transmit and receive data (operation S1605).

The electronic device 100, if identifying that the hotspot parameter and/or the access permission device information is changed (operation S1610), may transmit the TCP/UDP message to the first client device 10 (operation S1615). The TCP/UDP message is a unicast message and may include the changed hotspot parameter.

The first client device 10, if the TCP/UDP message is received, may update the existing hotspot parameter to the changed hotspot parameter (operation S1620).

Thereafter, the electronic device 100 may transmit the de-authentication message to the first client device 10 (operation S1625) and communication connection between the electronic device 100 and the first client device 10 may be disconnected.

The first client device 10 may identify the channel C as the priority channel and may start to listen to the channel C (operation S1630).

The electronic device 100 may broadcast a beacon through the channel C (S1635). Here, the beacon may include the updated hotspot parameter.

The first client device 10 may receive the beacon based on the updated hotspot parameter and thus, may transmit a probe request to the electronic device 100 (operation S1640). According to an embodiment, the SSID included the probe request may be the updated SSID.

The electronic device 100, if the probe request is received through the channel C from the first client device 10, may transmit the probe response through the channel C (operation S1645).

The first client device 10, if the probe response is received through the channel C, may transmit an authentication request (operation S1650). Here, the authentication request may include the updated password, that is, the password included in the TCP/UDP message.

The electronic device 100 may transmit an authentication response to the authentication request transmitted from the first client device 10 to the first client device 10 (operation S1655).

The first client device 10, if the authentication response is received from the electronic device 100, may transmit a connection request (operation S1660). The electronic device 100 receiving the connection request may transmit a connection response to the first client device 10 (operation S1665).

If the first client device 10 receives the connection response, communication between the electronic device 100 and the first client device 10 may be reconnected (operation S1670).

According to various embodiments, if the AP and/or the hotspot parameter of the mobile hotspot and/or the access permission device information are changed, a device of which access is permitted may automatically connect to the AP and/or mobile hotspot.

The aforementioned methods, according to various embodiments of the present disclosure, may be implemented in a form of an application installable in the existing electronic device. Also, the methods, according to various examples of the present disclosure as aforementioned, may be performed by using a deep learning-based artificial neural network (or a deep artificial neural network), that is, a learning network model.

Also, the aforementioned methods, according to various examples of the present disclosure, may be implemented only with a software upgrade or a hardware upgrade with respect to the existing electronic device.

Also, it may be possible to perform various examples of the present disclosure as above through an embedded server included in the electronic device or an external server of the electronic device.

According to an embodiment of the present disclosure, various examples described above may be implemented as software including instructions stored in machine (e.g., a computer) readable storage media. The machine may refer to a device which calls instructions stored in the storage media and is operable according to the called instructions, wherein the machine may include an electronic device (e.g., an electronic device A), according to the disclosed embodiments. If the instructions are executed by a processor, the processor may perform a function corresponding to the instructions directly or by using other components under control of the processor. The instructions may include a code generated or executed by a compiler or an interpreter. The machine readable storage media may be provided in a form of non-transitory storage media. Here, the term ‘non-transitory’ merely means that the storage media do not include a signal and are tangible, wherein the term does not distinguish a case that data is stored in the storage media semi-permanently from a case that data is stored in the storage media temporarily.

Also, according to an embodiment of the present disclosure, a method, according to various examples described above, may be provided to be included in a computer program product. The computer program product may be traded between a seller and a buyer as goods. The computer program product may be distributed in a form of a machine readable storage medium (e.g., compact disc read only memory (CD-ROM)) or on-line via an application store (e.g., Play Store™). In the case of on-line distribution, at least part of the computer program product may be stored at least temporarily or may be generated temporarily in a storage medium such as memory of a server of a manufacturer, a server of an application store, or a relay server.

Also, each of components (e.g., a module or a program), according to the various embodiments above, may be configured as a single item or a plurality of items, wherein a partial subcomponent of the aforementioned relevant subcomponents may be omitted or another subcomponent may be further included in various embodiments. Mostly or additionally, some components (e.g., a module or a program) may be integrated into one item and may identically or similarly perform a function implemented by each of the relevant components before the integration. According to various embodiments, operations performed by a module, a program, or another component may be executed sequentially, in parallel, repetitively, or heuristically, at least part of the operations may be executed in different orders or be omitted, or another operation may be added.

As above, the preferable examples of the present disclosure are shown and described but it is obvious that the present disclosure is not limited to the aforementioned specific examples and various modifications may be implemented by those skilled in the art without deviating from the gist of the present disclosure claimed in the scope of claims, wherein these modifications should not be independently understood from the technical spirit or scope of the present disclosure.

What is claimed is:

1. An electronic device comprising:
a communication interface;
memory storing instructions and access permission client device information; and
one or more processors coupled with the communication interface and the memory, and configured to execute the instructions,
wherein the instructions, when executed by the one or more processors individually or collectively, cause the electronic device to:
based on identifying that at least one of a hotspot parameter or the access permission client device information is changed, transmit, through the communication interface, a first de-authentication message comprising the hotspot parameter to a first client device of which access is permitted and transmit, through the communication interface, a second de-authentication message to a second client device of which access is not permitted; and
based on receiving a probe request from the first client device, perform reconnection with the first client device by transmitting, through the communication interface, a probe response to the first client device.

2. The electronic device of claim 1, wherein the first de-authentication message comprises a first reason code,
wherein the second de-authentication message comprises a second reason code, the hotspot parameter, and reconfiguration timer information,
wherein the hotspot parameter comprises at least one of service set identifier (SSID) information, password information, band information, or channel information, and
wherein the reconfiguration timer information comprises expected time information of a hotspot reset operation to be performed by the electronic device.

3. The electronic device of claim 2, wherein the instructions, when executed by the one or more processors individually or collectively, further cause the electronic device to:
based on receiving, from the first client device, the probe request based on the reconfiguration timer information, transmit the probe response to the first client device, and
wherein the first client device has been updated based on the hotspot parameter transmitted by the electronic device.

4. The electronic device of claim 3, wherein the instructions, when executed by the one or more processors individually or collectively, further cause the electronic device to:
based on receiving, from the first client device, the probe request through a priority channel based on the hotspot parameter, transmit, to the first client device, the probe response through the priority channel; and
based on receiving, from the first client device, the probe response through another channel, transmit, to the first client device, the probe request through the another channel.

5. The electronic device of claim 1, wherein the instructions, when executed by the one or more processors individually or collectively, further cause the electronic device to:
unicast the first de-authentication message and the second de-authentication message and broadcast a beacon message comprising a service set identifier (SSID); and
based on receiving, from the first client device, the probe request based on the first client device receiving the beacon message, transmit the probe response to the first client device,
wherein the first client device has been updated based on the hotspot parameter transmitted by the electronic device.

6. The electronic device of claim 1, wherein the instructions, when executed by the one or more processors individually or collectively, further cause the electronic device to:
based on at least one of the hotspot parameter or the access permission client device information being changed and a disconnected device being identified from among access permission client devices, broadcast a beacon message comprising a service set identifier (SSID);
based on the probe request comprising a media access control (MAC) address and an SSID being received from a third client device, determine whether the access permission client device information comprises the received MAC address and the received SSID; and
based on the received MAC address and the received SSID being identified, perform reconnection with the third client device by transmitting, to the third client device, the probe response comprising the identified MAC address and the identified SSID.

7. The electronic device of claim 6, wherein the instructions, when executed by the one or more processors individually or collectively, further cause the electronic device to:
based on a current SSID of the electronic device being a new first SSID, broadcast the beacon message comprising the new first SSID and at least one existing SSID; and
receive, from the third client device, the probe request comprising the MAC address and the SSID based on the at least one existing SSID in the beacon message.

8. The electronic device of claim 1, wherein the instructions, when executed by the one or more processors individually or collectively, further cause the electronic device to:
based on identifying that at least one of the hotspot parameter or the access permission client device information is changed, transmit, to the first client device, a transmission control protocol (TCP)/user datagram protocol (UDP) message comprising the hotspot parameter to the first client device and transmit, to the first client device, a de-authentication message.

9. The electronic device of claim 1, wherein the instructions, when executed by the one or more processors individually or collectively, further cause the electronic device to:
based on the hotspot parameter being changed, provide a user interface (UI) configured to update the access permission client device information; and
update the access permission client device information based on a user command received from the UI.

10. A system comprising:
a host device; and
a first client device of which access is permitted; and
wherein the host device is configured to, based on identifying that at least one of a hotspot parameter or access permission client device information is changed, transmitting a first de-authentication message comprising the hotspot parameter to the first client device and transmitting a second de-authentication message to a second client device of which access is not permitted,
wherein the first client device is configured to, based on receiving, from the host device, the first de-authentication message comprising the hotspot parameter, transmitting, to the host device, a probe request based on the hotspot parameter, and
wherein the host device is further configured to, based on receiving, from the first client device, the probe request, perform reconnection with the first client device by transmitting a probe response to the first client device.

11. The system of claim 10, wherein the first client device is further configured to:
transmit the probe request through a priority channel based on the hotspot parameter after waiting for a predetermined time period based on reconfiguration timer information in the second de-authentication message;
wait for receipt of the probe response in the priority channel; and
based on the probe response being not received through the priority channel, transmit the probe request through another channel.

12. A method for communication connection of an electronic device, comprising:
based on identifying that at least one of a hotspot parameter or access permission client device information is changed, transmitting a first de-authentication message comprising the hotspot parameter to a first client device of which access is permitted and transmitting a second de-authentication message to a second client device of which access is not permitted; and
based on a probe request being received from the first client device, transmitting a probe response to the first client device to perform reconnection with the first client device.

13. The method of claim 12, wherein the first de-authentication message comprises a first reason code,
wherein the second de-authentication message comprises a second reason code, the hotspot parameter, and reconfiguration timer information,
wherein the hotspot parameter comprises at least one of service set identifier (SSID) information, password information, band information, or channel information, and
wherein the reconfiguration timer information comprises expected time information of a hotspot reset operation to be performed by the electronic device.

14. The method of claim 13, wherein the performing the reconnection with the first client device comprises:
based on receiving, from the first client device, the probe request based on the reconfiguration timer information, transmitting the probe response to the first client device, and
wherein the first client device has been updated based on the hotspot parameter transmitted by the electronic device.

15. The method of claim 14, further comprising:
based on receiving, from the first client device, the probe request through a priority channel based on the hotspot parameter, transmit, to the first client device, the probe response through the priority channel; and
based on receiving, from the first client device, the probe response through another channel, transmit, to the first client device the probe request through the another channel.

16. The method of claim 12, wherein the transmitting the second de-authentication message to the second client device comprises:
unicasting the first de-authentication message and the second de-authentication message and broadcasting a beacon message comprising a service set identifier (SSID); and
wherein the transmitting the probe response to the first client device comprises:
based on receiving, from the first client device, the probe request based on the first client device receiving the beacon message, transmitting the probe response to the first client device,
wherein the first client device has been updated based on the hotspot parameter transmitted by the electronic device.

17. The method of claim 12, further comprises:
based on at least one of the hotspot parameter or the access permission client device information being changed and a disconnected device being identified from among access permission client devices, broadcasting a beacon message comprising a service set identifier (SSID);
based on the probe request comprising a media access control (MAC) address and an SSID being received from a third client device, determining whether the access permission client device information comprises the received MAC address and the received SSID; and
based on the received MAC address and the received SSID being identified, performing reconnection with the third client device by transmitting, to the third client device, the probe response comprising the identified MAC address and the identified SSID.

18. The method of claim 17, wherein the broadcasting a beacon message comprises:
based on a current SSID of the electronic device being a new first SSID, broadcasting the beacon message comprising the new first SSID and at least one existing SSID; and
receiving, from the third client device, the probe request comprising the MAC address and the SSID based on the at least one existing SSID in the beacon message.

19. The method of claim 12, further comprises:
based on identifying that at least one of the hotspot parameter or the access permission client device information is changed, transmitting, to the first client device, a transmission control protocol (TCP)/user datagram protocol (UDP) message comprising the hotspot parameter to the first client device and transmit, to the first client device, a de-authentication message.

20. The method of claim 12, further comprises:
based on the hotspot parameter being changed, providing a user interface (UI) configured to update the access permission client device information; and
updating the access permission client device information based on a user command received from the UI.
